(19) United States
(12) Patent Application Publication
(10) Pub. No.: US 2002/0039671 A1
(43) Pub. Date: Apr. 4, 2002

(54) Battery with protection circuit for preventing malfunction

(75) Inventor: Yuji Yanagisawa, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/967,298

(22) Filed: Sep. 28, 2001

(30) Foreign Application Priority Data
Oct. 3, 2000 (JP) 2000-308012

(51) Int. Cl. H01M 10/42

(52) U.S. Cl. 429/7; 429/61

(57) ABSTRACT

The invention provides a battery with a protection circuit that is capable of preventing malfunction of the protection circuit securely by improving the shielding effect of a shield member that covers the protection circuit. A substrate is provided on an upper surface of a power source comprising two batteries, and a detection circuit and a protection switch are provided on the substrate. The detection circuit detects overcharge and over-discharge of the batteries, and the detection circuit controls the protection switch. When overcharging, over-discharging, or overcurrent is detected, charging or discharging of the batteries is shut down. The detection circuit and the protection switch are covered with the shield member with interposition of an insulating member. The shield member is connected to a − terminal with solder, and connected to a negative electrode of the battery with interposition of the insulating member in a high frequency fashion.

### BACKGROUND OF THE INVENTION

1. Field of the Invention

This invention relates to a battery with a protection circuit, and more particularly relates to a battery with a protection circuit used as a power source of a radio system.

2. Description of the Related Art

FIG. 3 is a circuit diagram of a battery with a protection circuit, and comprises a power source 21 having batteries 21a and 21b connected in series, a protection circuit 24, and a + (plus) terminal 22 and a − (minus) terminal 23 connected to the both ends of the power source 21. A load not shown in the drawing is connected between the + terminal 22 and the − terminal 23, and grounded at the portion connected to the − terminal 23. The protection circuit 24 is provided with a protection switch 25 that is interpolated between the power source 21 and the load and a detection circuit 26 that detects abnormalities of the batteries 21a and 21b and turns off protection switches 25a and 25b.

The protection switch 25 comprises a charging shutdown switch 25a that shuts down charging to the batteries 21a and 21b and a discharging shutdown switch 25b that shuts down discharging from the battery to the load, and these switches are configured in the form of FET. The source of the charging shutdown switch 25a is connected to the negative electrode 21f of the battery 21b and the drain of the charging shutdown switch 25a is connected to the source of the discharging shutdown switch 25b, and the drain of the discharging shutdown switch 25b is connected to the − terminal 23.

The detection circuit 26 has a positive terminal 26a connected to the positive electrode of the power source (the positive electrode 21c of the battery 21a), a middle point terminal 26b connected to the negative electrode 21d of the battery 21a and the positive electrode 21e of the battery 21b, a negative electrode 26c connected to the negative electrode of the power source 21 (the negative electrode 21f of the battery 21b), a delay terminal 26d connected to a detection delay capacitor 27, a voltage detection terminal 26e connected to the positive electrode of the power source (the positive electrode 21c of the battery 21a) with interposition of a resistor 28a, an overcurrent detection terminal 26f connected to the − terminal 23 with interposition of a resistor 28b, a control terminal 26g connected to the gate of the protection switch 25a, and a control terminal 26h connected to the gate of the protection switch 25b.

In the normal condition, the voltage of the control terminals 26g and 26h are maintained at low level, and the charging shutdown switch 25a and the discharging shutdown switch 25b of the protection switch 25 are maintained in ON.

When the battery becomes overcharged, the potential difference between the voltage detection terminal 26e and the negative terminal 26c exceeds a predetermined value, the detection circuit 26 detects the overcharge of the batteries 21a and 21b, the control terminal 26g becomes high level, and the charging shutdown switch 25a of the protection switch 25 is turned off.

On the other hand, when the battery becomes over-discharged, the voltage difference between the voltage detection terminal 26e and the negative terminal 26c drops to a value equal to or lower than another predetermined value, the detection circuit 26 detects over-discharge, the control terminal 26h rises to high level, and the discharging shutdown switch 25b of the protection switch 25 is turned off.

An overcurrent that flows through the batteries 21a and 21b causes an increased current flow through the protection switch 25, the voltage drop between both ends of the protection switch 25 increases, the potential difference between the overcurrent detection terminal 26f and the negative terminal 26c increases resultantly, the detection circuit 26 detects the overcurrent, the control terminal 26g or 26h becomes high level, and the charging shutdown switch 25a or discharging shutdown switch 25b of the protection switch 25 is turned off.

The battery is configured as shown in a perspective view in FIG. 4. The battery 21a is disposed on the battery 21b with interposition of an insulating film 29a, and a substrate 30 on which the protection circuit 24 is mounted is provided partially on the upper surface of the battery 21a. The detection circuit 26 having an integrated circuit structure and the protection switch 25 having an integrated circuit structure are disposed on the substrate 30. Furthermore, the positive electrode 21c of the battery 21a is connected to a wiring pattern on the substrate 30 (not shown) through a metal foil 31a, the negative electrode 21f of the battery 21b is connected to a wiring pattern on the substrate 30 through a metal foil 31b, and the negative electrode 21d of the battery 21a and the positive electrode 21e of the battery 21b are connected to a wiring pattern on the substrate 30 through a metal foil 31c. Furthermore, the + terminal 22 consisting of a metal foil and the − terminal 23 consisting of a metal foil are connected to the substrate 30, and the + terminal 22 and the − terminal 23 are disposed on the side surface of the batteries 21a and 21b with interposition of an insulating film 29b.

An insulating member 32 consisting of a vinyl film is disposed so as to cover the substrate 30 partially including the detection integrated circuit 31 and the protection switch integrated circuit 32. However, the − terminal 23 is not covered with the insulating member 32. A shield member consisting of a copper foil is provided on the insulating member 32, and the shield member 33 is connected to the − terminal 23 with a solder 34.

Because, in the abovementioned conventional battery with a protection circuit, the shield member 33 is grounded at one soldered point, the two shield members 25 and 26 of the protection circuit 4 disposed at the point far from the solder 34 are not shielded sufficiently. As the result, an external radio wave passes through the shield member 33 and is superimposed on a current that flows through the protection circuit 24 due to electromagnetic induction, and the protection circuit 24 can cause malfunction. When the protection circuit 24 causes malfunction, the protection switch 25 is turned off even when overcharge, over-discharge, or overcurrent does not occur, and supply of power source voltage to the load can be shut down. Particularly the battery is used for a radio system that usually has an antenna near the battery with a protection circuit, which is exposed to a strong radio wave, and the low shield effect of the shield member 33 can cause malfunction of the radio system easily.

### SUMMARY OF THE INVENTION

In view of the abovementioned problem, it is the object of the present invention to provide a battery with a protection circuit that prevents malfunction of the protection circuit of a battery due to a radio wave emitted from an antenna of the radio system.

To solve the abovementioned problem, a battery with a protection circuit is provided with a power source having at least one battery, a protection circuit comprising a protection switch interpolated between a load having one end that is grounded and the power source and a detection circuit that detects overcharging or over-discharging of the battery and turns off the protection switch, a shield member that shields at least the protection switch, and an insulating member provided between the shield member and the protection circuit and between the shield member and the battery, wherein the shield member is connected to one end of the load in a DC fashion, and wherein the shield member is connected to an electrode other than a negative electrode of the battery that is connected to one end of the load in a high frequency fashion. Thereby the shielding effect is improved and the malfunction of the protection switch is prevented.

The battery with the protection circuit of the present invention is provided with a negative electrode terminal connected to a negative electrode of the power source, a voltage detection terminal connected to the positive electrode of a power source, an overcurrent detection terminal that is used to measure a current that flows through the protection switch, and a control terminal that generates a signal to turn off the protection switch, wherein the shield member shields the voltage detection terminal, the overcurrent detection terminal, and the control terminal. Thereby the malfunction of the protection switch is prevented.

### BRIEF DESCRIPTION OF THE DRAWINGS

FIG. 1 is a circuit diagram of a battery with a protection circuit of the present invention.

FIG. 2 is a perspective view of the battery with the protection circuit of the present invention.

FIG. 3 is a circuit diagram of a conventional battery with a protection circuit.

FIG. 4 is a circuit diagram of the conventional battery with the protection circuit.

### DETAILED DESCRIPTION OF THE INVENTION

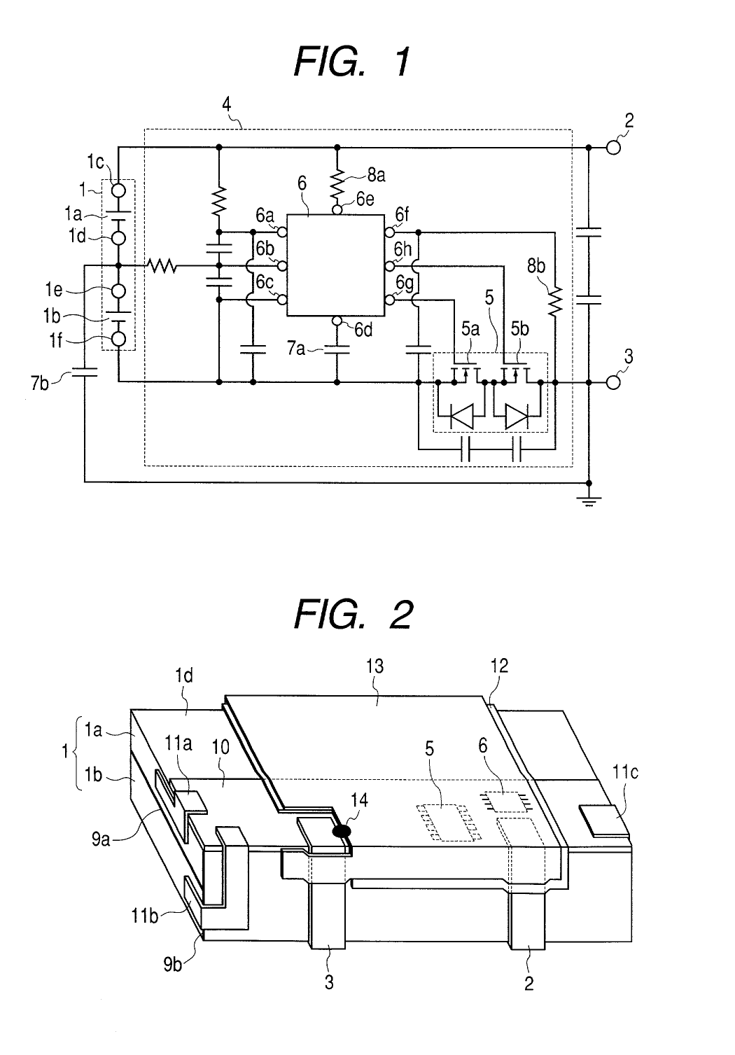

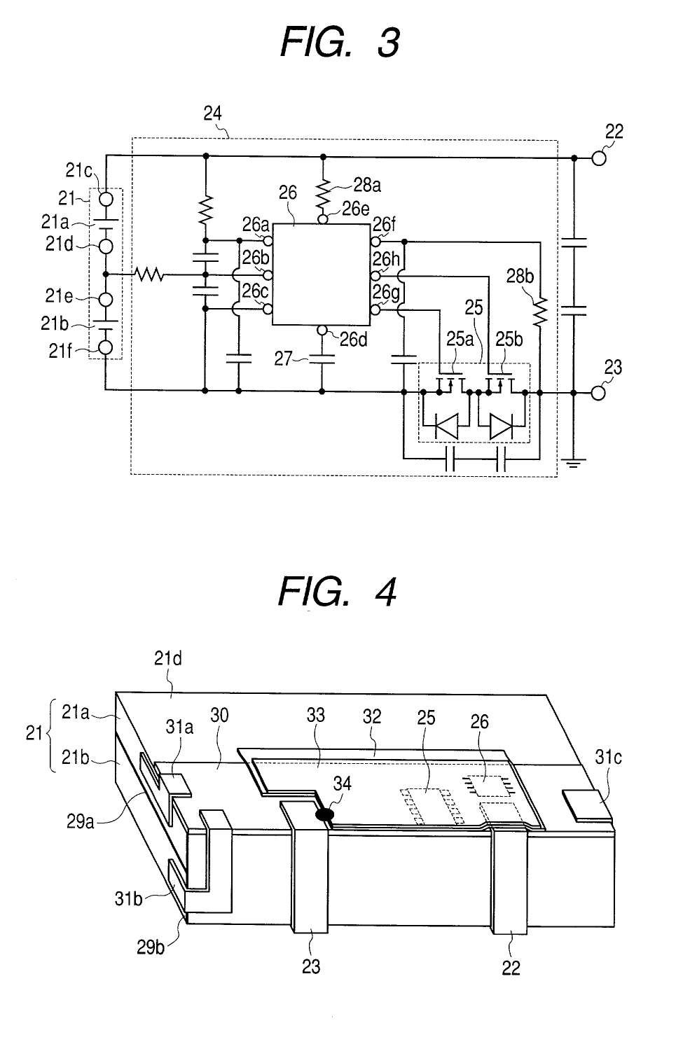

FIG. 1 is a circuit diagram showing a battery with a protection circuit, and the battery comprises a power source 1 having batteries la and lb connected in series, a protection circuit 4, and a + terminal 2 and a − terminal 3 connected to both ends of the power source 1 respectively. A load not shown in the drawing is connected between the + terminal 2 and the − terminal 3, and is ground at the portion that is connected to the − terminal 3. The protection circuit 4 has a protection switch 5 interpolated between the power source 1 and the load and a detection circuit 6 that is served to detect abnormalities of the batteries 1a and 1b and to turn off the protection switch 5.

The protection switch 5 comprises a charging shutdown switch 5a that is served to shut down charging to the battery, and a discharging shutdown switch 5b that is served to shut down discharging from the battery to the load, and both switches are configured in the form of FET. The source of the charging shutdown switch 5a is connected to the negative electrode if of the battery 1b, the drain of the charging shutdown switch 5a is connected to the source of the discharging shutdown switch 5b, and the drain of the discharging shutdown switch 5b is connected to the − terminal 3.

The detection circuit 6 is provided with a positive electrode terminal 6a connected to the positive electrode (the positive electrode 1c of the battery 1a) of the power source, a middle point terminal 6b connected to the negative electrode Id of the battery 1a and the positive electrode 1e of the battery 1b, a negative electrode terminal 6c connected to the negative electrode (the negative electrode if of the battery 1b) of the power source 1, a delay terminal 6d connected to the detection delay capacitor 7, a voltage detection terminal 6e connected to the positive electrode (the positive electrode 1c of the battery 1a) of the power source through a resistor 8a, an overcurrent detection terminal 6f connected to the − terminal 3 through a resistor 8b, a control terminal 6g connected to the gate of the protection switch 5a , and a control terminal 6h connected to the gate of the protection switch 5b.

The protection switch 5 and the detection circuit 6 are covered with the insulating member 12 and shield member 13 as described hereinafter, and the negative electrode 1d of the battery 1a and the shield member 13 form a capacitor 7b together.

In the normal condition, the voltage of the control terminals 6g and 6h is maintained low level, and the charging shutdown switch 5a and the discharging shutdown switch 5b of the protection switch 5 are maintained ON.

When the battery becomes overcharged,, the voltage difference between the voltage detection terminal 6e and the negative terminal 6c attains to a value equal to or higher than a predetermined value and the detection circuit 6 detects overcharging of the batteries 1a and 1b resultantly, and the control terminal 6g becomes high level and the charging shutdown switch 5a of the protection switch 5 is turned off.

On the other hand, when the battery becomes over-discharged, the voltage difference between the voltage detection terminal 6e and the negative electrode terminal 6c drops to a value equal to or lower than another predetermined value and the detection circuit 6 detects over-discharge, and the control terminal 6g becomes high level and the discharging shutdown switch 5b of the protection switch 5 is turned off.

Furthermore, when an overcurrent flows through the batteries 1a and 1b, a current that flows through the protection switch 5 increases to result in a large voltage drop between both ends of the protection switch 5, the voltage difference between the overcurrent detection terminal 26f and the negative terminal 6c becomes large, the detection circuit 6 detects the overcurrent, the control terminal 6g or 6h becomes high level, and the charging shutdown switch 5a or the discharging shutdown switch 5b of the protection switch 5 is turned off.

FIG. 2 is a perspective view showing the configuration of the battery with the protection circuit. The batteries 1a and 1b are rectangular and placed one on the other. The right side face not shown in the drawing of the lower side battery 1b is served as the positive electrode 1e and other five faces are served as the negative electrode 1f. The battery 1a is disposed on the battery 1b with interposition of the insulating film 9a, and the left side face is served as the positive electrode 1c and other five faces are served as the negative electrode 1d. The negative electrode 1d of the battery 1a is connected to the positive electrode 1e of the battery 1b with the metal foil 11c, and the batteries 1a and 1b are connected in series. A substrate 10 on which the protection circuit 4 is mounted is provided partially on the upper surface of the battery 1a. The detection circuit 6 having an integrated circuit structure and the protection switch 5 having an integrated circuit structure are disposed on the substrate 10. Furthermore, the positive electrode 1c of the battery 1a is connected to a wiring pattern (not shown) on the substrate 10 through the metal foil 11a, the negative electrode if of the battery 1b is connected to a wiring pattern on the substrate through the metal foil 11b, and the negative electrode id of the battery 1a and the positive electrode 1e of the battery 1b are connected to a wiring pattern on the substrate 10a through the metal foil 11c. Furthermore, the + terminal 2 consisting of a metal foil and the − terminal 3 consisting of a metal foil are connected to the substrate 10, and the + terminal 2 and the − terminal 3 are disposed on the side surfaces of the batteries 1a and 1b with interposition of the insulating film 9b.

The insulating member 12 consisting of a vinyl film is disposed on the upper surface of the substrate 10 so as to cover the upper surface of the battery 1a partially, to cover the side surface of the battery 1a partially, and to cover the detection circuit 6 and the protection switch 5. The insulating member 12 does not cover the top side of the − terminal 3. The shield member 13 consisting of a copper foil is disposed on the insulating member 12 and the − terminal 3 so as to partially cover the − terminal 3, and the shield member 13 is connected in series to the − terminal 3 with solder 14. Because the upper surface and the side surface of the battery 1a are served as the negative electrode 1d of the battery 1a, the negative electrode 1d of the battery 1a, the insulating member 12, and the shield member 13 form the capacitor 7b. As the result, the shield member 13 is connected to the negative electrode 1d of the battery 1a in a high frequency fashion.

Because the battery with a protection circuit of the present invention has the shield member 13 that is grounded by being connected in series to one end of the load and connected in a high frequency fashion to the electrode other than the negative electrode of the battery to be connected to one end of the load, the shield member 13 is grounded in a high frequency fashion at two points, the shielding effect is improved as a whole, and the malfunction of the protection switch 5 covered with the shield member 13 is prevented.

Because the battery with the protection circuit of the present invention has the voltage detection terminal 6e, the overcurrent detection terminal 6f, and the control terminals 6g and 6h that are shielded by means of the shield member, the malfunction of the detection circuit 6 is prevented.

What is claimed is:

1. A battery with a protection circuit provided with:
a power source having at least one battery;
a protection circuit comprising a protection switch interpolated between a load having one end that is grounded and the power source and a detection circuit that detects overcharging or over-discharging of the battery and turns off the protection switch;
a shield member that shields at least the protection switch; and
an insulating member provided between the shield member and the protection circuit and between the shield member and the battery,
wherein the shield member is connected to one end of the load in a DC fashion, and
wherein the shield member is connected to an electrode other than a negative electrode of the battery that is connected to one end of the load in a high frequency fashion.

2. The battery with the protection circuit according to claim 1, wherein the battery with the protection circuit is provided with:
a negative electrode terminal connected to a negative electrode of the power source;
a voltage detection terminal connected to a positive electrode of the power source;
an overcurrent detection terminal that is used to measure a current that flows through the protection switch; and
a control terminal that generates a signal to turn off the protection switch,
wherein the shield member shields the voltage detection terminal, the overcurrent detection terminal, and the control terminal.
